(19) United States
(12) Patent Application Publication
(10) Pub. No.: US 2008/0020800 A1
(43) Pub. Date: Jan. 24, 2008

(54) TWO-IN-ONE CONNECTOR FOR BOTH SIM CARD OF MOBILE PHONE AND MEMORY CARD

(76) Inventor: Yingzan Xu, Dongguan City (CN)

Correspondence Address: SCHMEISER, OLSEN & WATTS, 22 CENTURY HILL DRIVE, SUITE 302, LATHAM, NY, 12110, US

(21) Appl. No.: 11/773,988

(22) Filed: Jul. 6, 2007

(30) Foreign Application Priority Data
Jul. 21, 2006 (CN) 200610061788.2

(51) Int. Cl. H04B 1/38

(52) U.S. Cl. 455/558

(57) ABSTRACT

A two-in-one connector for both SIM card of mobile phone and memory card, comprises a terminal block, a plurality of first conductive terminals for connecting the SIM card inserted, a plurality of second conductive terminals for connecting the memory card inserted, a slot block, and a top cover, wherein the terminal block comprises a first terminal block and a second terminal block adjacent to the first terminal block; the first conductive terminals and the second conductive terminals are respectively installed in the first terminal block and the second terminal block; the slot block comprises a first base plate, a rear wall, a first side wall, a partition wall formed by extending downwards from an inner side of the first base plate, a second base plate extending from bottom of the partition wall, and a second side wall extending upwards from the second base plate; the first base plate is provided with a first opening corresponding to the contact portions of the first conductive terminals; the second base plate is provided with a second opening corresponding to the contact portions of the second conductive terminals; the top cover comprises a cover body covering on the slot block.

### TECHNICAL FIELD

The present invention relates to a connector used inside a mobile phone, in particular a connector with reduced thickness used for simultaneously inserting both SIM card of mobile phone and memory card.

### BACKGROUND ART

Nowadays, mobile phone supporting memory card has come forth, wherein, the memory card serves to expand the storage capacity of such mobile phone. With more and more urgent demand in the market for the storage capacity of the mobile phone, especially with popularization of the intelligent mobile phone, the memory card has become one of the standard configurations of a mobile phone. It was anticipated that the amount of the mobile phone with memory card slot would increase to two hundred and fifty million till 2005, and the amount of the mobile phone with memory card will count for 30% of the total amount of goods out all through the world in 2006.

Presently, the memory card for mobile phone mainly includes SD card, MMC card, miniSD card, TF card, Memory stick card, MS Micro card, MMC Micro card and Micro SD card, and so on. Both MMC Micro card and Micro SD card are the smallest mini memory cards all over the world. Accordingly, they have more advantages and may be applied to various digital products due to the super small volume.

However, design of the mobile phone tends to be more and more light, thin, short and small. So it is needed in the art to provide a lighter and thinner connector for simultaneously inserting both SIM (Subscriber Identity Module) card of mobile phone and a memory card.

### SUMMARY OF THE INVENTION

The object of the present invention is to provide a two-in-one connector for both SIM card of mobile phone and memory card, which can be used for simultaneously inserting both SIM card of mobile phone and a memory card and has a thin holistic thickness.

In order to achieve the above objective, the present invention provides a two-in-one connector for both SIM card of mobile phone and memory card comprising a terminal block, a plurality of first conductive terminals with contact portions for connecting the SIM card inserted, a plurality of second conductive terminals with contact portions for connecting the memory card inserted, a slot block pivoted at a rear end of the terminal block, and a top cover, wherein the terminal block comprises a first terminal block and a second terminal block adjacent to the first terminal block; the first conductive terminals and the second conductive terminals are respectively installed in the first terminal block and the second terminal block; the slot block comprises a first base plate corresponding to one side of the first terminal block, a rear wall formed by extending upwards from a rear end of the first base plate, a first side wall formed by extending upwards from an outer side of the first base plate, a partition wall formed by extending downwards from an inner side of the first base plate, a second base plate formed by extending from bottom of the partition wall away from the first base plate, and a second side wall formed by extending upwards from an outer side of the second base plate; the first base plate is provided with a first opening corresponding to the contact portions of the first conductive terminals; the second base plate is provided with a second opening corresponding to the contact portions of the second conductive terminals; the top cover comprises a cover body covering on the slot block; a space surrounded by the first base plate, the rear wall, the first side wall, the second side wall and the cover body constitutes a first slot for receiving the SIM card; a space surrounded by the second base plate, the partition wall, the second side wall and the inserted SIM card constitutes a second slot for receiving the memory card.

The present invention has the following advantages: because the upper surface of the memory card is directly against the SIM card, a firm installation that the memory card can not move any more, a steady coupling between the memory card and the second conductive terminals, and a reduced holistic thickness of the connector may be achieved at the same time.

### BRIEF DESCRIPTION OF THE DRAWINGS

FIG. 1 is a perspective view of the two-in-one connector for both SIM card of mobile phone and memory card according to the invention, wherein the connector is unfolded;

FIG. 2 is a perspective view of the two-in-one connector for both SIM card of mobile phone and memory card according to the invention, wherein the connector is folded;

FIG. 3 is a perspective view of the two-in-one connector for both SIM card of mobile phone and memory card according to the invention, wherein both a SIM card and a Micro SD card are to be inserted in the unfolded connector;

FIG. 4 is a perspective view of the two-in-one connector for both SIM card of mobile phone and memory card according to the invention, wherein both a SIM card and a Micro SD card have been inserted in a folded connector;

FIG. 5 is a perspective view of the slot block of the two-in-one connector for both SIM card of mobile phone and memory card according to the invention;

FIG. 6 is a bottom view of the SIM card used with the two-in-one connector for both SIM card of mobile phone and memory card according to the invention;

FIG. 7 is a bottom view of the Micro SD card used with the two-in-one connector for both SIM card of mobile phone and memory card according to the invention;

FIG. 8 is a schematically perspective view of showing the relative position of the SIM card and the Micro SD card inserted in the two-in-one connector for both SIM card of mobile phone and memory card according to the invention.

### DETAILED DESCRIPTION OF THE PREFERRED EMBODIMENTS

The present invention will be described in details with reference to the drawings.

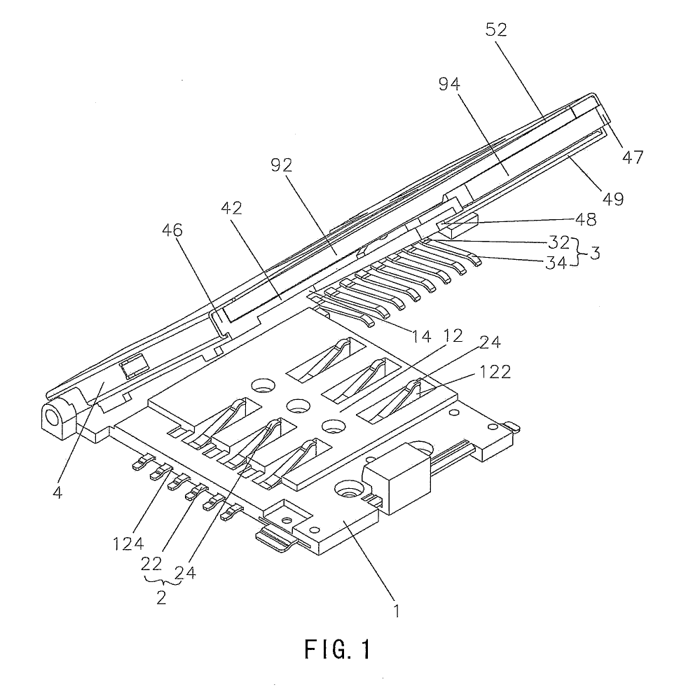

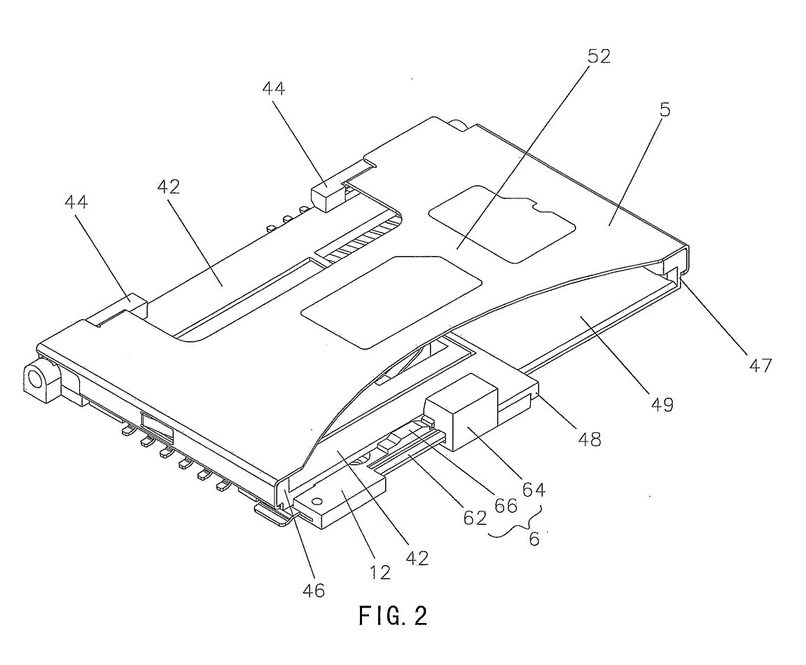

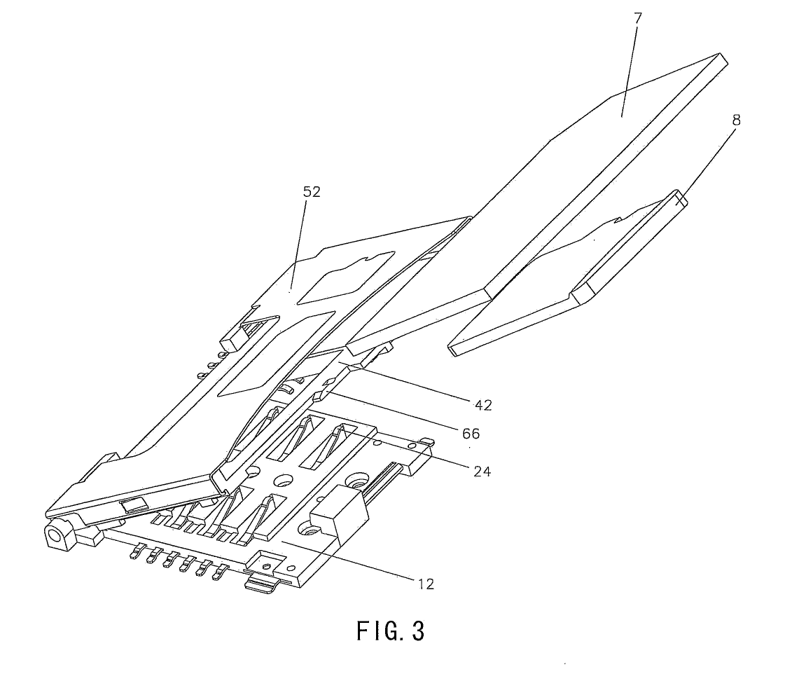

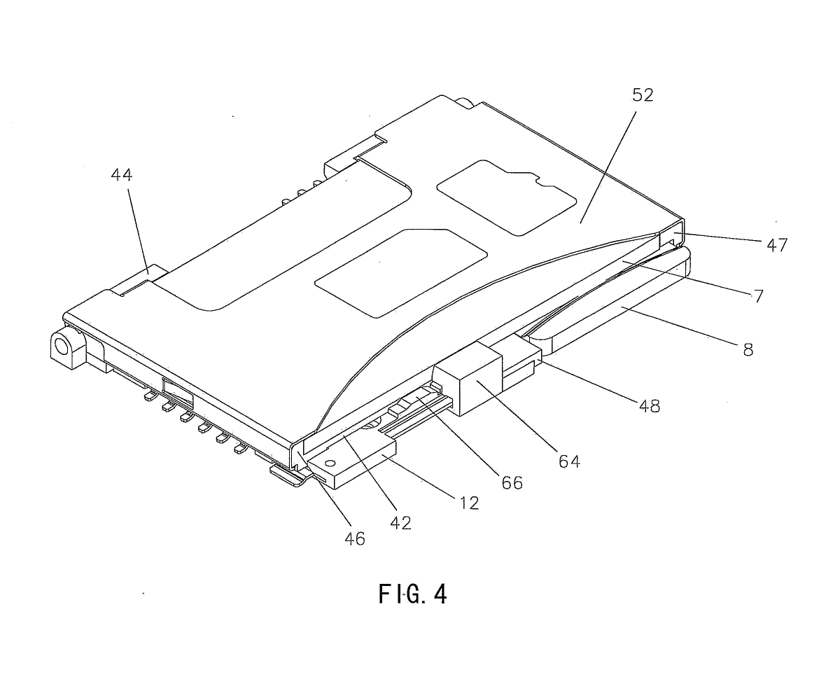

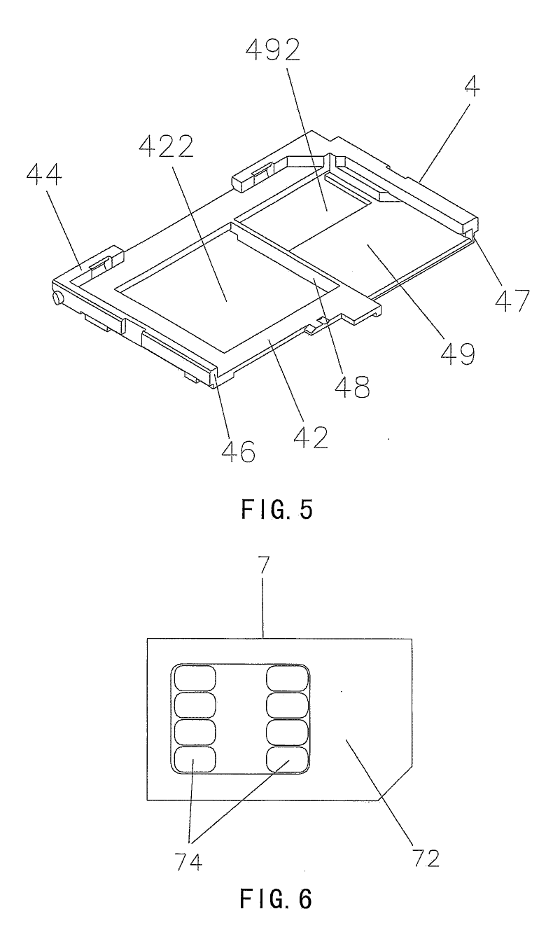

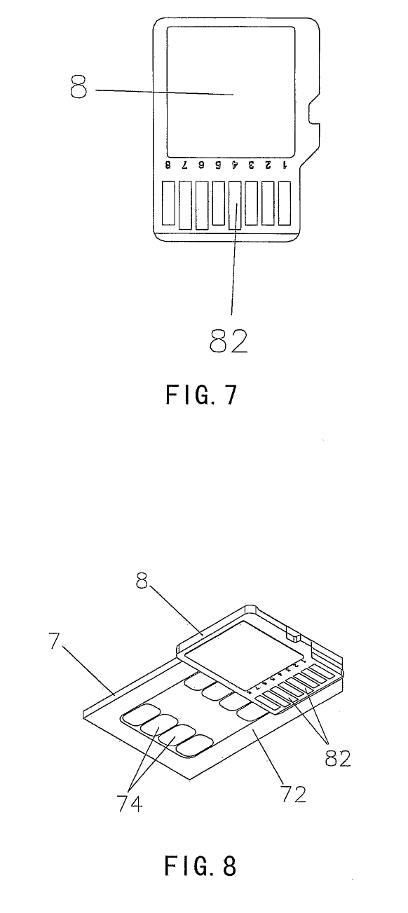

As shown in FIGS. 1˜8, the present invention provides a two-in-one connector for both SIM card of mobile phone and memory card comprising a terminal block 1, a plurality of first conductive terminals 2, a plurality of second conductive terminals 3, a slot block 4, a top cover 5, and a lock device 6.

The terminal block 1 comprises a first terminal block 12 and a second terminal block 14 adjacent to the first terminal block 12.

The first terminal block 12 is provided at the left-of the terminal block 1 and forms in a shape of a rectangle as a whole, on which a plurality of terminal receiving slots 122 are provided. The first terminal receiving slots 122 are provided with a plurality of the first terminal slots 124 at the left side thereof.

The second terminal block 14 is provided at the right of the terminal block 1 and forms in a shape of a long and narrow strip as a whole adjacent to the rear end of the terminal block 1, on which a plurality of second terminal slots (not shown) parallel to each other are provided.

The first conductive terminals 2 for correspondingly connecting the SIM card 7 of mobile phone are accordingly installed in the first terminal block 12 and serve to couple the SIM card 7 of mobile phone with the first conductive terminals 2.

Each of the first conductive terminals 2 comprises a fixing portion 22 and a vaulted contact portion 24 which bends upwards while extending from one end of the fixing portion 22. The fixing portions 22 of the first conductive terminals 2 are respectively inserted into the first terminal slots 124, and the contact portions 24 are received in the first terminal receiving slots 122 and extend to a position higher than the upper surface of the first terminal block 12.

The second conductive terminals 3 for correspondingly inserting the Micro SD card 8 are accordingly installed in the second terminal block 14 and serve to couple the Micro SD card 8 with the second conductive terminals 3.

Each of the second conductive terminals 3 comprises a fixing portion 32 and a vaulted contact portion 34 which bends upwards while extending from the fixing portion 32. The fixing portions 32 of the plurality of the second conductive terminals 3 are respectively inserted into the plurality of the second terminal slots, and the contact portions 24 extend forwards and are located at the right side portion of the first terminal block 12.

The slot block 4 is rotatably pivoted at the rear end of the terminal block 1 and comprises a first base plate 42, a rear wall 44, a left side wall 46, a partition wall 48, a second base plate 49, and a right side wall 47.

The first base plate 42 at the left of the slot block 4 is corresponding to and parallel to the first terminal block 12 and is provided at the center thereof with a first opening 422. The first opening 422 corresponds to the contact portions 24 of the first conductive terminals 2 and allows the contact portions 24 to pass therethrough when the SIM card 7 is inserted.

The rear wall 44 is formed by perpendicularly extending upwards from the edge of the rear end of the first base plate 42.

The left side wall 46 is formed by perpendicularly extending upwards from the edge of the left end of the first base plate 42.

The partition wall 48 is formed by perpendicularly extending downwards for a distance from the edge of the right end of the first base plate 42.

The second base plate 49 at the right of the slot block 4 is corresponding to the second terminal block 14 and is formed by extending rightwards from the bottom of the partition wall 48 with paralleling to the first base plate 42. The second base 49 is provided at the center thereof with a second opening 492 which corresponds to the contact portions 34 of the second conductive terminals 3 and allows the contact portions 34 to pass therethrough when the Micro SD card 8 is inserted.

The right side wall 47 is formed by perpendicularly extending upwards from the edge of the right end of the second base plate 49. The upper end of the right side wall 47 extends leftwards for a distance for contributing to the orientation of the inserted SIM card 7.

The top cover 5 is installed on the slot block 4 by the mean of fastening and comprises a cover body 52 covering on the slot block 4.

The lock device 6 comprises a runner 62 provided at the front end of the first terminal block 12, a slide block 64 capable of sliding leftwards and rightwards within the runner 62, a press block 66 provided at the front end of the first base plate 42 of the slot block 4. The slide block 64 presses the press block 66 so as to closely lock an adherence between the terminal block 1 and the slot block 4 when the slide block 64 slides to the right end.

The SIM card 7 comprises a contact face 72. A plurality of conductive pieces 74 respectively contacting the contact portions 24 of the first conductive terminals 2 are provided at the left of the contact surface 72 and a blank is provided at the right of the contact surface 72.

The SIM card 7 is received in a first slot 92 which is a space surrounded by the first base plate 42, the rear wall 44, the left side wall 46, the right side wall 47, and the cover body 52 constitutes for receiving the SIM card 7.

When the front end of the SIM card 7 is inserted into the first slot 92 and then contacts against the rear wall 44, the SIM card 7 is deemed as being inserted in place. When the SIM card 7 has been inserted in place and the terminal block 1 is locked in adherence to the slot block 4, the contact portions 24 of the first conductive terminals 2 pass through the first opening 422 and correspondingly contact with the conductive pieces 74 of the SIM card 7. Thereby, the SIM card 7 is electrically connected with the first conductive terminals 2.

A space under the right side portion of the contact surface 72 can be utilized due to the blank at the right of the contact surface 72 of the SIM card 7. Therefore, the space surrounded by the second base plate 49, the partition wall 48, the right side wall 47 and the contact surface 72 of the SIM card 7 constitutes a second slot 94 for receiving the Micro SD card 8.

During the installation, the Micro SD card 8 is inserted after the SIM card 7 is installed in position; next the terminal block 1 is adhered to the slot block 2; then they are firmly locked by the lock device 6. The contact portions 34 of the second conductive terminals 3 pass through the second opening 492 and correspondingly contact the conductive pieces 82 of the Micro SD card 8. Thereby, the Micro SD card 8 is electrically connected with the second conductive terminals 3. Because the upper surface of the Micro SD card 8 is directly adhered to the contact surface 72 of the SIM card, a firm installation that the Micro SD card 8 can not move any more, a steady electrical connection between the Micro SD card 8 and the second conductive terminals 3, and a reduced holistic thickness of the connector may be achieved at the same time.

Although only the first embodiment of the invention is described on the above, the invention can be embodied in many other forms. For example:
1. A blocking plate may be formed through extending between the partition wall 48 and the right side wall 47 and be located between the SIM card 7 and the Micro SD card 8 when the two cards are installed. In this manner, the firm installation of the Micro SD card 8 and the reduced holistic thickness of the connector still can be achieved.
2. The second conductive terminals 3 may be matchable for coupling a micro MMC card or a micro MS card with the only modification of the width and the highness of the second terminal block 14. That's, the object and the effect of the invention still can be achieved in this way.
3. The left and right positions of the first terminal block 12 and the second terminal block 14 are relative, so they may be exchanged according to the practice. For example, in a new embodiment, the first terminal block 12 is provided on the right side and the second terminal block 14 is provided on the left side. The positions of the other components are changed accordingly. In this manner, the object and the effect of the invention same as that of the first embodiment still can be achieved.

What is claimed is:

1. A two-in-one connector for both SIM card of mobile phone and memory card, comprising: a terminal block, a plurality of first conductive terminals with contact portions for connecting the SIM card inserted, a plurality of second conductive terminals with contact portions for connecting the memory card inserted, a slot block pivoted at a rear end of the terminal block, and a top cover, wherein,
the terminal block comprises a first terminal block and a second terminal block adjacent to the first terminal block;
the first conductive terminals and the second conductive terminals are respectively installed in the first terminal block and the second terminal block;
the slot block comprises a first base plate corresponding to one side of the first terminal block, a rear wall formed by extending upwards from a rear end of the first base plate, a first side wall formed by extending upwards from an outer side of the first base plate, a partition wall formed by extending downwards from an inner side of the first base plate, a second base plate formed by extending from bottom of the partition wall away from the first base plate, and a second side wall formed by extending upwards from an outer side of the second base plate;
the first base plate is provided with a first opening corresponding to the contact portions of the first conductive terminals;
the second base plate is provided with a second opening corresponding to the contact portions of the second conductive terminals;
the top cover comprises a cover body covering on the slot block;
a space surrounded by the first base plate, the rear wall, the first side wall, the second side wall and the cover body constitutes a first slot for receiving the SIM card;
a space surrounded by the second base plate, the partition wall, the second side wall and the inserted SIM card constitutes a second slot for receiving the memory card.

2. The two-in-one connector for both SIM card of mobile phone and memory card as claim 1, wherein the memory card is a Micro SD card, a Micro MMC card or a Micro MS card.

3. The two-in-one connector for both SIM card of mobile phone and memory card as claim 1, wherein a blocking plate is extended between the partition wall and the second side wall so as to be located between the SIM card to be inserted and the memory card to be inserted.

4. The two-in-one connector for both SIM card of mobile phone and memory card as claim 1, wherein the second base plate is parallel to the first base plate.

5. The two-in-one connector for both SIM card of mobile phone and memory card as claim 1, wherein the first terminal block is provided at the left of the terminal block and the second terminal block is provided at the right of the terminal block, while the first base plate is provided at the left of the slot block and the second base plate is provided at the right of the slot block.

6. The two-in-one connector for both SIM card of mobile phone and memory card as claim 1, wherein the first terminal block is provided at the right of the terminal block and the second terminal block is provided at the left of the terminal block, while the first base plate is provided at the right of the slot block and the second base plate is provided at the left of the slot block.

7. The two-in-one connector for both SIM card of mobile phone and memory card as claim 1, wherein the first terminal block is provided with a plurality of first receiving slots in which the contact portions of the first conductive terminals are received respectively.

8. The two-in-one connector for both SIM card of mobile phone and memory card as claim 1, wherein the first opening allows the contact portions of the first conductive terminals to pass therethrough and contact the respective conductive pieces of the SIM card after the SIM card is inserted into the connector.

9. The two-in-one connector for both SIM card of mobile phone and memory card as claim 1, wherein the second opening allows the contact portions of the second conductive terminals to pass therethrough and contact the respective conductive pieces of the memory card after the memory card is inserted into the connector.
